(19) United States
(12) Patent Application Publication
(10) Pub. No.: US 2006/0032107 A1
(43) Pub. Date: Feb. 16, 2006

(54) Structure of single fishing line guide for fishing rod

(76) Inventor: Moon-jae Yu, Seoul (KR)

Correspondence Address: Mark G. Lappin;McDermott Will & Emery LLP, 28 State Street, Boston, MA, 02109, US

(21) Appl. No.: 10/916,136

(22) Filed: Aug. 11, 2004

(51) Int. Cl. A01K 87/04

(52) U.S. Cl. 43/24

(57) ABSTRACT

Disclosed is a structure of a single fishing line guide of a fishing rod, including: a frame provided with a centering hole formed therethrough for guiding a fishing line; and a supporter extended from the frame and bent such that a bent portion is formed between the supporter and the frame and contacts the fishing rod to fixedly support the frame, wherein the bent portion is protruded from a supporting area and contacts the fishing rod, thereby supporting the frame.

### BACKGROUND OF THE INVENTION

1. Field of the Invention

The present invention relates to a structure of a single fishing, line guide for a fishing rod, and more particularly to a structure of a single fishing line guide of a fishing rod, in which a supporting area of the fishing line guide contacting the fishing rod is formed by punching a bent portion of the fishing line guide, thereby supporting the fishing line guide by a simple process and reducing the production costs of the fishing rod.

2. Description of the Related Art

Generally, a fishing rod comprises a plurality of fishing line guides arranged in a longitudinal direction.

The fishing line guide comprises a frame having a centering hole formed therethrough for guiding a fishing line, and a supporter extended integrally from the lower part of the frame, thereby being fixed to a fishing rod.

Japanese Patent Laid-open No. Heisei 08-252040 discloses a structure of a single fishing line guide, in which protrusions are formed on a frame so as to absorb external impact, and Japanese Patent Laid-open No. Heisei 10-313744 discloses the installation of a structure for reinforcing a single fishing line guide.

Japanese Patent Laid-open No. Heisei 11-000084 discloses a fixed structure of a fishing line guide for a fishing rod by reinforcing a conventional single fishing line guide when the fishing line guide is attached to the fishing rod, and Japanese Patent Laid-open 2001-095433 discloses a reinforced structure of a single fishing line guide, which is attached to a fishing rod by a protrusion formed on the fishing rod.

Japanese Utility Model No. 51-4238 discloses a reinforced structure of a single fishing line guide, in which protrusions are formed on a part of the single fishing line guide opposite to a frame.

Similar Designs 24 and 25 of Japanese Design Registration No. 426576, and Japanese Design Registration No. 795933 and its similar Design 1 disclose structures of a fishing line guide, in which a frame of a fixed portion of a fishing rod is connected to the opposite side and protruded to the outside, and Japanese Design Registration No. 1129582 discloses a structure of a single fishing line guide, in which a protrusion for protecting the fishing line guide from external impact is formed on one side of the fishing line guide.

In order to support the above-described conventional structures of fishing line guides to the fishing rod, an additional member is formed on a supporting area of the fishing line guide or outer circumference of the fishing rod is deformed so as to support the fishing line guide. Accordingly, the conventional structures of the fishing line guides cause complexity in manufacturing the fishing rods and increase the production costs of the fishing rods.

### SUMMARY OF THE INVENTION

Therefore, the present invention has been made in view of the above problems, and it is an object of the present invention to provide a structure of a single fishing line guide for a fishing rod, in which a supporting area of the fishing line guide contacting the fishing rod is protruded outwards by punching, so that the fishing line guide is supported by the fishing rod by the protruded supporting area to prevent a fishing line from being shaken, thereby simply fixing the fishing line guide to the fishing rod and reducing the production costs of the fishing rod.

In accordance with the present invention, the above and other objects can be accomplished by the provision of a structure of a single fishing line guide of a fishing rod, comprising: a frame provided with a centering hole formed therethrough for guiding a fishing line; and a supporter extended from the frame and bent such that a bent portion is formed between the supporter and the frame and contacts the fishing rod to fixedly support the frame, wherein the bent portion is protruded from a supporting area and contacts the fishing rod, thereby supporting the frame.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating the installation of a single fishing line guide for a fishing rod in accordance with one embodiment of the present invention;

FIG. 2 is an enlarged view of the portion “A” of FIG. 1;

FIG. 3 is a cross-sectional view of the single fishing line guide of FIG. 1;

FIG. 4 is a perspective view illustrating the installation of a single fishing line guide for a fishing rod in accordance with another embodiment of the present invention;

FIG. 5 is an enlarged view of the portion “B” of FIG. 4; and

FIG. 6 is a cross-sectional view of the single fishing line guide of FIG. 4.

### DESCRIPTION OF THE PREFERRED EMBODIMENTS

Now, preferred embodiments of the present invention will be described in detail with reference to the annexed drawings.

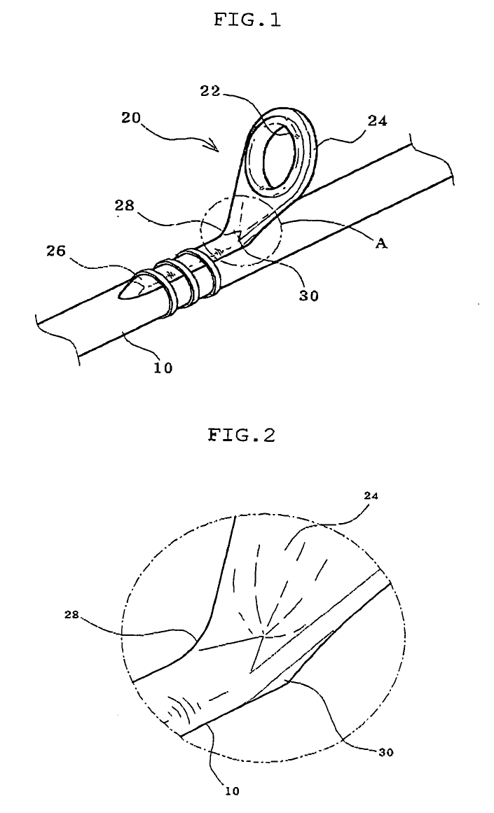

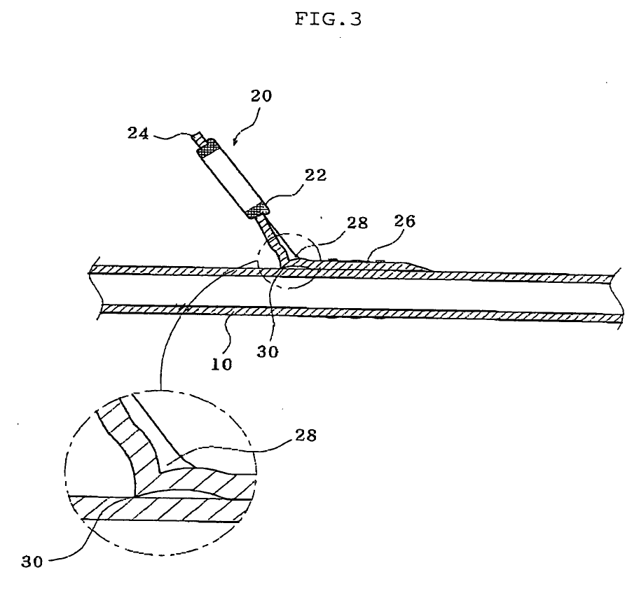

FIG. 1 is a perspective view illustrating the installation of a single fishing line guide for a fishing rod in accordance with one embodiment of the present invention. FIG. 2 is an enlarged view of the portion “A” of FIG. 1, and FIG. 3 is a cross-sectional view of the single fishing line guide of FIG. 1.

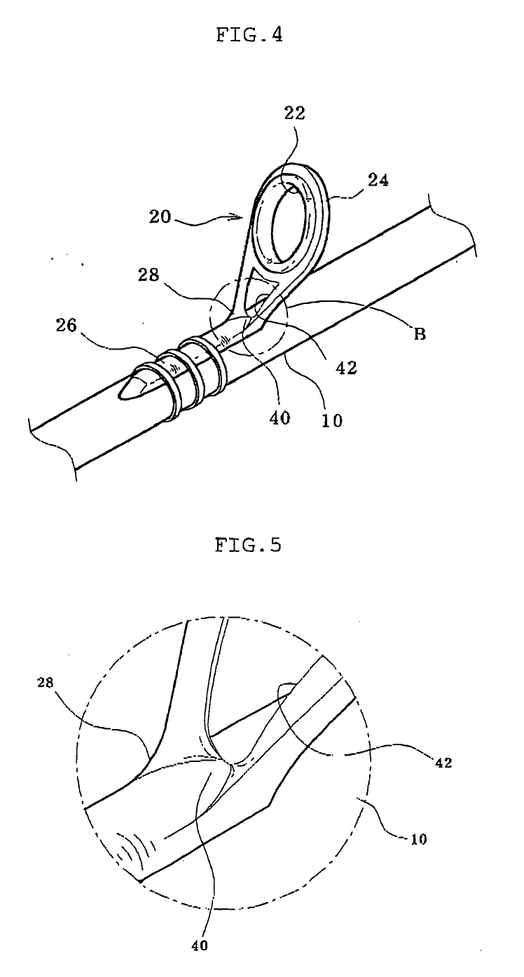

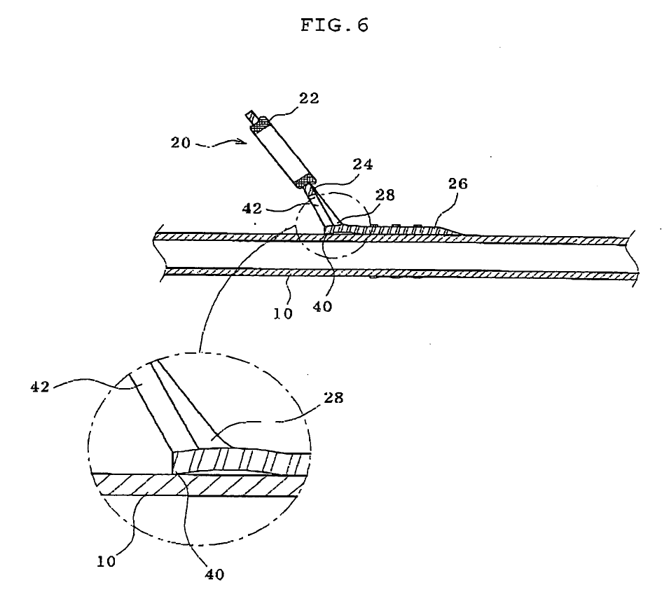

FIG. 4 is a perspective view illustrating the installation of a single fishing line guide for a fishing rod in accordance with another embodiment of the present invention. FIG. 5 is an enlarged view of the portion “B” of FIG. 4, and FIG. 6 is a cross-sectional view of the single fishing line guide of FIG. 4.

As shown in FIGS. 1 to 3, the fishing rod 10 has a plurality of fishing line guides 20 fixed thereto in the longitudinal direction.

Here, the fishing line guides 20 in accordance with one embodiment of the present invention denote single fishing line guides.

Each of the fishing line guides 20 comprises a frame 24 having a centering hole 22 formed therethrough for passing and guiding a fishing line, and a supporter 26 extended from the frame 24 and fixed to the fishing rod 10.

A bent portion 28 is formed between the supporter 26 and the frame 24, thereby causing the frame 24 to be bent from the supporter 26 by a designated angle.

A supporting area 30 is protruded outwardly from the surface of the bent portion 28.

That is, the supporting area 30 is formed by punching the central portion of the bent portion 28 using a punching device (not shown) so that the supporting area 30 is protruded downwardly and contacts the surface of the fishing rod 10.

The bent portion 28 is depressed and partially bent, thereby allowing the frame 24 not to be easily warped outwards by tension of the fishing line.

Since the supporting area 30 contacts the fishing rod 10 to support the frame 24, the single fishing line guide 20 of the present invention has the same effects as that of a dual fishing line guide.

As shown in FIGS. 4 to 6, the fishing line guide 20 in accordance with another embodiment of the present invention comprises the frame 24 having the centering hole 22 formed therethrough, and the supporter 26 extended from the frame 24.

The bent portion 28 is formed between the supporter 26 and the frame 24, thereby causing the frame 24 to be bent from the supporter 26 by a designated angle.

Here, the distance from the lower end of the centering hole 22 of the frame 24 to the supporter 26 is comparatively long.

A through hole 42 is formed through the lower part of the frame 24.

The through hole 42 is formed from the lower part of the centering hole 22 to the bent portion 28.

A supporting area 40 is formed on the bent portion 28 by punching the central portion of the bent portion 28 placed under the through hole 42 adjacent to the supporter 26 using the punching device (not shown) so that the bottom of the supporting area 30 is protruded downwardly and contacts the surface of the fishing rod 10.

Accordingly, the frame 24 stably contacts the fishing rod 10, and is not easily warped by tension of the fishing line.

Since portions of the frame 24 around both side edges of the through hole 42 are bent so that the portions of the frame 24 converge inwards, the frame 24 is firmly fixed to the fishing rod 10.

As apparent from the above description, the present invention provides a structure of a single fishing line guide of a fishing rod, in which the lower part of the frame provided with a centering hole formed therethrough is punched or perforated, and is firmly fixed to the fishing rod together with a supporter, thereby allowing the fishing line guide to be fixed to the fishing rod by a simple process and reducing the production costs of the fishing rod.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A fishing line guide for a fishing rod having an outer lateral surface, comprising:
a frame provided with a centering hole formed therethrough for guiding a fishing line; and
support element having a bent portion extending from said frame and a supporter extending from said bent portion, said supporter having an undersurface adapted for contact with said outer lateral surface of the fishing rod to support said frame,
wherein a supporting area protrudes from said bent portion and is adapted for contact with said outer lateral surface of the fishing rod, thereby supporting the frame.

2. The fishing line guide set forth in claim 1, wherein the frame is bent upwards from the supporting area.

3. The fishing line guide set forth in claim 1 or 2, wherein said frame further defines a through hole between said centering hole and the supporting area.
